(19) United States
(12) Patent Application Publication
(10) Pub. No.: US 2025/0008240 A1
(43) Pub. Date: Jan. 2, 2025

(54) IMAGING SYSTEM AND METHOD WITH ADAPTIVE SCANNING ACTIVE ILLUMINATION

(71) Applicant: AEye, Inc., Dublin, CA (US)

(72) Inventors: Hod Finkelstein, Albany, CA (US); Allan Steinhardt, Dublin, CA (US)

(73) Assignee: AEye, Inc., Dublin, CA (US)

(21) Appl. No.: 18/711,873

(22) PCT Filed: Dec. 22, 2022
(86) PCT No.: PCT/US2022/053819

§ 371 Date: May 20, 2024

Related U.S. Application Data
(60) Provisional application No. 63/294,315, filed on Dec. 28, 2021.

(51) Int. Cl. H04N 25/779; H04N 23/74; H04N 25/531; H04N 25/532; H04N 25/535

(52) U.S. Cl. CPC H04N 25/779; H04N 23/74; H04N 25/531; H04N 25/532; H04N 25/535

(57) ABSTRACT

Systems and methods can employ an emitter with adaptive active illumination in combination with a receiver that images a field of view illuminated by the emitter. An example active illumination camera system may comprise a light source that generates light output for sequentially illuminating a scene, a scanner that scannably steers the light output to targeted regions in the scene, a photodetector array comprising a photodetector array having a plurality of photodetector pixels that sense incident light from the scene and generate signals representative of the sensed incident light via integration of photo-generated charge for the pixels over time, and a circuit that generates image frames of the scene based on the generated signals, identifies regions of interest in the scene, and dynamically controls the light source and the scanner so that the steered light output exhibits a pattern that targets the identified regions with an increase in light energy

### CROSS-REFERENCE AND PRIORITY CLAIM TO RELATED PATENT APPLICATION

This patent application claims priority to U.S. provisional patent application 63/294,315, filed Dec. 28, 2021, and entitled “Imaging System and Method with Adaptive Scanning Active Illumination”, the entire disclosure of which is incorporated herein by reference.

### INTRODUCTION

It is believed that improvements are needed in the art for active illumination cameras. Most cameras used for generating 2-dimensional (2D) images rely on passive illumination. But, when operating in environments with low light or darkness, passive illumination will often result in insufficient optical signal from the object or objects in the field of view. For active illumination, many cameras employ flood illumination. However, flood illumination illuminates the field of view regardless of the location of objects within it, resulting in high power consumption, heat dissipation and cost.

In order to image a wide field of view (FOV) and/or image objects at long range during low-light level conditions, high-power illumination or very long exposures are conventionally required. Consequently, with conventional low-light cameras, excessive heating may occur and/or expensive cooling is required. In some applications (e.g., in a car-mounted camera or in military usage cases), there is a limit on power consumption, and this limit constrains camera performance.

In certain imaging applications, e.g., in car mounted cameras, when using active illumination, excessive optical power can result in saturation or in blooming from specular reflectors and retroreflectors.

Furthermore, for many imaging applications (e.g., those that will need to operate in low-light conditions), in order to attain a sufficiently high signal-to-noise ratio (SNR), either the integration time of the receiver must increase (which yields a low frame rate) or the resolution must decrease (e.g., adding or “binning” N pixels reduces the resolution N-times but increases the SNR by the square root of N). This resolution or frame rate degrades in low-light conditions.

Also, in certain imaging applications (e.g., security cameras or other use cases where covert imaging is desired), it is desirable to image a large field of view in a diverse set of ambient operating conditions (e.g., in daylight or night time; in clear or adverse weather) and image fine details on distant objects (such as people or animals). Conventional security cameras and the like will typically require strong light projectors to achieve these goals; but such strong light projectors will alert suspects that they are being imaged.

Accordingly, in an effort to improve active illumination camera systems, described herein are various systems and methods that employ an emitter with adaptive active illumination in combination with a receiver that images a field of view illuminated by the emitter.

For example, the active illumination system may comprise (1) a light source that generates a light output for sequentially illuminating a scene to be imaged, (2) a scanner that scannably steers the light output to targeted regions in the scene, (3) a photodetector array comprising a photodetector array having a plurality of photodetector pixels that sense incident light from the scene and generate signals representative of the sensed incident light via integration of photo-generated charge for the pixels over time, and (4) a circuit that (i) generates image frames of the scene based on the generated signals, (ii) identifies regions of interest in the scene, and (iii) dynamically controls the light source and the scanner so that the steered light output exhibits a pattern that targets the identified regions with an increase in light energy.

These and other features and advantages of the invention will be described in greater detail below.

### BRIEF DESCRIPTION OF THE DRAWINGS

FIG. 1 depicts an example camera system that employs adaptive active illumination.

FIG. 2A depicts an example process flow for adaptive active illumination with respect to the camera system of FIG. 1.

FIGS. 2B and 2D show example shot patterns for a search mode of operation by the camera system of FIG. 1.

FIGS. 2C and 2E shows example shot patterns for a targeted interrogation mode of operation by the camera system of FIG. 1.

FIG. 3 depicts an example system architecture for a camera system with adaptive active illumination.

FIG. 4 depicts an example scanner for the camera system of FIG. 1.

FIG. 5 depicts an example scanner system architecture for the camera system of FIG. 1.

FIG. 6 depicts an example receiver system architecture for the camera system of FIG. 1.

FIGS. 7-10 depict example timing diagrams for signal acquisition and readout for different embodiments of a receiver.

FIG. 11 depicts an example control process for an example dataflow for the camera system of FIG. 1.

### DETAILED DESCRIPTION OF EXAMPLE EMBODIMENTS

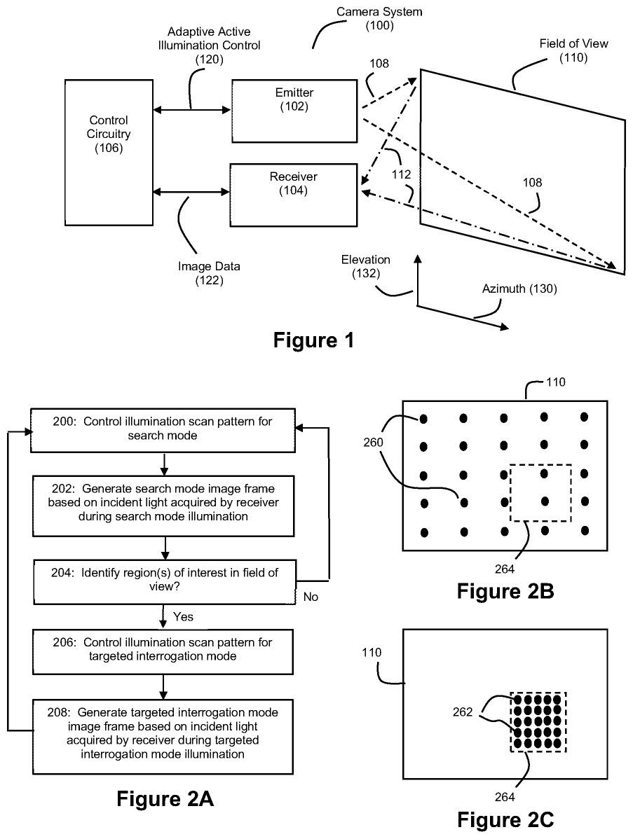

FIG. 1 shows an example camera system 100 that includes adaptive active illumination. The camera system 100 comprises an emitter 102, a receiver 104, and control circuitry 106. The receiver 104 includes a photodetector circuit for sensing incident light 112 from the field of view 110 to generate image data 122 that represents a scene in this field of view 110. The image data 122 can be used for producing 2D image frames of scenes in the field of view 110. Emitter 102 produces a light output 108 that illuminates the field of view 110 to better enable the receiver 104 to image the field of view 110.

The light output 108 can be scanned by the emitter 102 across the field of view 110 according to dynamic scan patterns that are adaptively controlled by control circuitry 106. Accordingly, the emitter 102 can sequentially illuminate the field of view 110 with the light output 108 over time. For example, the light output 108 can be scanned along axes corresponding to the azimuth direction 130 and elevation direction 132 as indicated by FIG. 1. The control circuitry 106 can provide an adaptive active illumination control signal 120 to the emitter 102 to define how the light output 108 will be scanned across the field of view 110. For example, when regions of interest are identified in the field of view 110, the control circuitry 106 can provide an adaptive active illumination control signal 120 to the emitter 102 that causes the emitter 102 to exhibit a denser pattern of light output in the identified regions of interest relative to other portions of the field of view 110. This will have the effect of better illuminating the regions of interest so that better images of the regions of interest can be produced (while reducing the amount of time and energy that is spent illuminating portions of the field of view 110 that are not part of the regions of interest).

Meanwhile, incident light 112 from the field of view 110 is received by the receiver 104 and sensed by a photodetector circuit within the receiver 104. The photodetector circuit can comprise a photodetector array having a plurality of photodetector pixels (e.g., a focal plane array) along with associated signal processing circuitry for reading out signals from the pixels that represent the sensed incident light 112. Image data 122 that represents the field of view 110 can be generated from the sensed incident light 112. The camera system 100 can thus produce image frames of the field of view 110 based on this image data 122.

Moreover, the control circuitry 106 can process this image data 122 to identify the regions of interest that are to be targeted with illumination by the emitter 102. For example, the control circuitry 106 can process multiple frames of image data 122 to detect regions within the field of view 110 where motion is occurring (e.g., by detecting deltas from one image frame to the next). These regions of motion can be identified as regions of interest that are to be targeted with a denser pattern of the light output 108, and the control circuitry 106 can adjust the dynamic scan pattern of the light output 108 accordingly via the adaptive active illumination control signal 120. As another example, the control circuitry 106 can process frames of image data 122 to detect objects of interest depicted therein (e.g., a person, car, etc.), and the identified region of interest can be a portion of the field of view 110 that encompasses the detected object of interest. It should be understood that these are examples only and other techniques can be used to identify regions of interest for the adaptive active illumination (e.g., detecting regions of high contrast, etc.).

The control circuitry 106 can include one or more compute resources that are capable of carrying out the control and decision-making operations described herein. For example, such compute resources may include one or more microprocessors, field programmable gate arrays (FPGAs), and/or application-specific integrated circuits (ASICs) (e.g., the control circuitry 106 may include a system on a chip (SoC). Machine-readable code (e.g., software, firmware, etc.) can be resident on a non-transitory machine-readable storage medium (e.g., memory) to define the processing and control operations to be carried out by such computer resources.

The camera system 100 may exhibit a bistatic architecture where the emitter 102 emits light output 108 through a different aperture than the aperture through which the receiver 104 receives the incident light 112.

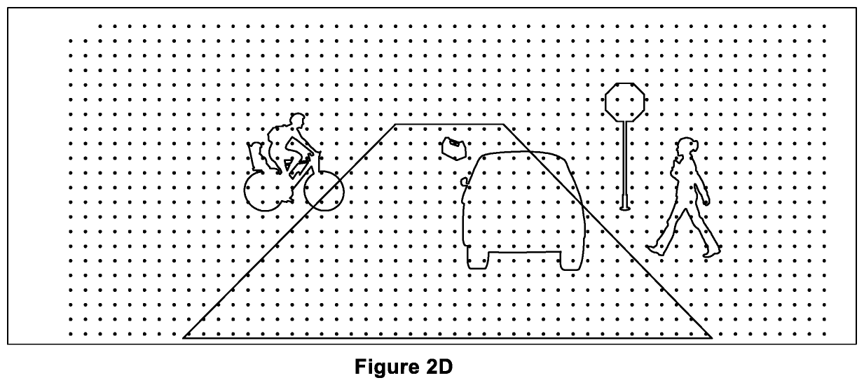

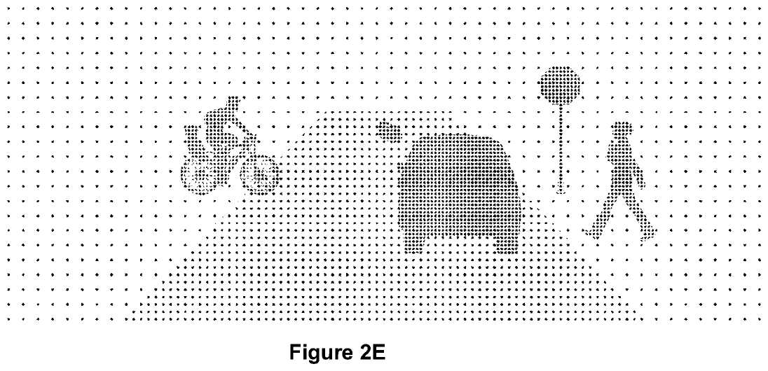

FIG. 2A shows an example process flow for the control circuitry with respect to dynamic control over the active illumination produced by the emitter 102.

At step 200, the control circuitry 106 controls the emitter 102 to operate in a search mode. When in the search mode, the emitter 102 scans the light output 108 in a scan pattern that provides sufficient illumination of the field of view 110 to support imaging. For example, the search mode scan pattern can exhibit uniformly spaced shots of optical energy. The amount of optical energy in these shots can be kept at a relatively low value in order to conserve power while still producing a desired amount of imaging resolution. Practitioners can choose to set the spacing and energy levels for the shots at desired amounts in view of their circumstances. For example, the emitter 102 may scan a row in the field of view over a 60 degree extent in 10 μsec. The emitter 102 may then fire four 1 mJ shots during the row scan at an average separation of 15 degrees between shots. The timing of the shots may be distributed such that after 50 scans of the same row by the emitter (where the emitter 102 fires 4 shots during each scan), the desired illumination of the subject row has been achieved and the emitter 102 can proceed to the next row for further illumination.

Meanwhile, at step 202, the control circuitry 106 generates a search mode image frame based on sensed image data 122 that represents the incident light acquired by the receiver 104 during the search mode illumination.

At step 204, a determination is made as to whether there are any regions of interest in the field of view 110. As noted above, the control circuitry 106 can process one or more previous image frames to make this determination. If no regions of interest are identified at step 204, the process flow can return to step 200 where the search mode illumination is continued. However, if one or more regions of interest are identified at step 204, the process flow proceeds to step 206.

At step 206, the control circuitry 106 controls the emitter 102 to operate in a targeted interrogation mode. When in the targeted interrogation mode, the emitter 102 scans the light output 108 in a scan pattern that increases the amount energy used to illuminate the identified region(s) of interest (relative to the amount of energy used to illuminate that region when in the search mode). For example, the targeted interrogation mode scan pattern can exhibit a greater density of optical energy within the region(s) of interest than was exhibited by the search mode scan pattern. For example, the targeted interrogation scan pattern can exhibit a denser pattern of optical energy shots that results in more optical energy per spatial unit within the identified region(s) of interest relative to the search mode scan pattern.

As an example, the shots of the targeted interrogation mode scan pattern can exhibit the same amount of energy as from the search mode scan pattern such as 1 mJ shots when continuing from the example discussed above, albeit where the targeted interrogation mode scan pattern has a higher density of these 1 mJ shots in the identified region(s) of interest. As another example, the shots of the targeted interrogation mode can exhibit a larger amount of energy than the shots from the search mode—such as 5 mJ shots. Moreover, it should also be understood that such larger energy shots can also be more densely spaced in the targeted interrogation mode if desired by a practitioner. For example, continuing from the example above where the search mode scan pattern results in 1 mJ shots, the targeted interrogation mode can result in 5 mJ shots that illuminate a region of interest (e.g., a central portion of the field of view) such that the illuminated spots are partially overlapping—such as shots with a separation of 0.1 degrees. It should be understood that these are examples only, and different shot energies and shot spacings can be employed for the search and targeted interrogation modes if desired by a practitioner.

An example of increased density for the targeted interrogation mode relative to the search mode is shown by a comparison of FIG. 2B (which shows an example spacing of light output shots 260 across the field of view 110 by the emitter 102 during a search mode) and FIG. 2C (which shows an example spacing of light output shots 262 across an identified region of interest 264 within the field of view 110. In this example, it can be seen that the targeted interrogation mode scan pattern does not include any shots 262 outside the region of interest 264. This increased density of light output energy in the region of interest 264 supports improved imaging of region of interest 264.

FIGS. 2D and 2E show another example of shot patterns for the search mode and targeted illumination mode shot pattern. FIG. 2D shows an example where the shots (as indicated by the dots of FIG. 2D) for the search mode shot pattern are uniformly spaced and superimposed over a scene that includes a road, a vehicle, a pedestrian, a bicyclist, and an object in the road. FIG. 2E shows an example where the targeted interrogation mode produces higher resolution in portions of the field of view corresponding to the regions of interest (namely, the road, vehicle, pedestrian, bicyclist, and road object) than in the portions of the field of view outside the regions of interest (via a denser spacing of shots in the regions of interest).

Meanwhile, at step 208, the control circuitry 106 generates a targeted interrogation mode image frame based on sensed image data 122 that represents the incident light acquired by the receiver 104 during the targeted interrogation mode illumination. The process flow can then return to step 200 for search mode operations.

If desired by a practitioner, the control circuitry 106 can combine the search mode image frame from step 202 with the targeted interrogation mode image frame from step 208. For example, the targeted interrogation mode image frame can be superimposed over or fused with the search mode image frame to produce a combined image frame with improved resolution/clarity in the region of interest 264.

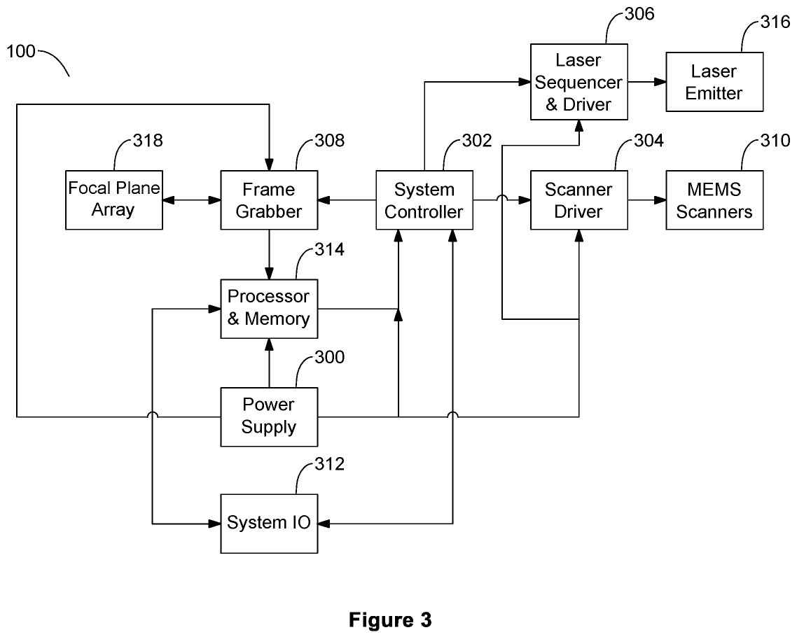

FIG. 3 shows an example system diagram showing various components that can be included as part of an example camera system 100. A power supply 300 provides voltage and current to the electrical components in the system 100. The system controller 302 sends instructions and timing signals (1) to the scanner driver 304 and the laser sequencer and driver 306 in the emitter 102 and (2) to the frame grabber 308 in the receiver 104. For example, the system controller 302 can send instructions for the laser driver 306 regarding when to fire and at what intensity. In embodiments where the receiver 104 employs selective pixel activation based on the illumination pattern of the emitter 102, the system controller 302 can also send instructions to the focal plane array 318 and corresponding circuitry regarding which pixels to activate (and when those pixels should be activated).

The scanner driver 304 drives scanner 310, which can be a MEMS scanner and may include one or more scannable mirrors, based on a scan table loaded through the system IO 312 or stored in system memory 314. The laser sequencer 306 sends electrical signals to the laser 316 to fire pulses at appropriate times, pulse widths and energies, as per the scan table. Incident light is received and sensed by the focal plane array 318 on the frame grabber 308 for translation into collected electrical signals that serve as image data 122 and organized into image frames. The frame grabber 308 outputs the collected electrical signals to processor 314 which applies appropriate filtering, synchronizations and processing to the baseline (search mode) and adaptive (targeted interrogation) image frames to derive an optimized frame which may be stored in memory 314 or sent via the system IO 312.

With this example, the control circuitry 106 can include system controller 302, processor/memory 314, power supply 300, and system IO 312. Furthermore, the control circuitry 106 can also include various components that are housed in modules for the emitter 102 and receiver 104, such as the scanner driver 304, laser sequencer/driver 306, and/or frame grabber 308.

### Emitter 102:

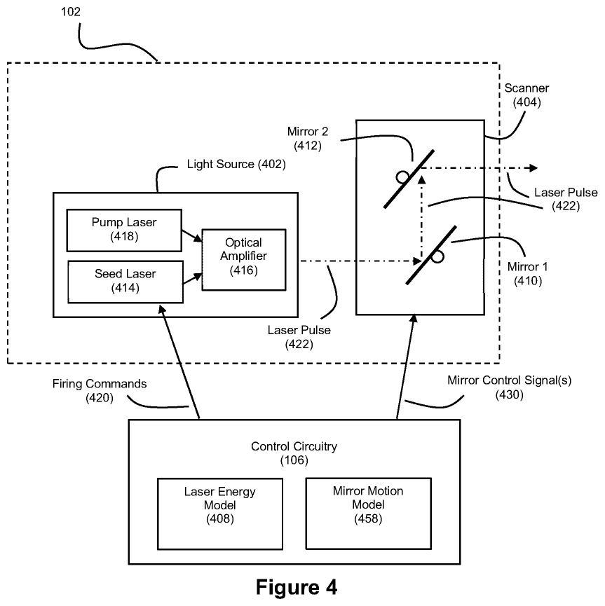

FIG. 4 shows an example embodiment for emitter 102. In the example of FIG. 4, the emitter 102 comprises a light source 402 and a scanner 404.

The light source 402 can take the form of a laser source that generates laser pulses 422 for transmission into the field of view 110 via the scanner 404. These laser pulses 422 can be interchangeably referred to as laser pulse shots (or more simply, as just “shots”). The field of view 110 will include different addressable coordinates (e.g., {azimuth, elevation} pairs), and the scanner 404 can operate to control, via scanning of mirrors 410 and 412, the target coordinates in the field of view 110 toward which the laser pulses 422 will be fired.

Light source 402 can use optical amplification to generate the laser pulses 422. In this regard, a light source 402 that includes an optical amplifier can be referred to as an optical amplification laser source 402. In the example of FIG. 4, the optical amplification laser source includes a seed laser 414, an optical amplifier 416, and a pump laser 418. In an example embodiment, the pump laser 418 can exhibit a fixed rate of energy buildup (where a constant amount of energy is deposited in the optical amplifier 416 per unit time). However, it should be understood that a practitioner may choose to employ a pump laser 418 that exhibits a variable rate of energy buildup (where the amount of energy deposited in the optical amplifier 416 varies per unit time). In the laser architecture of FIG. 4, the seed laser 414 provides the input (signal) that is amplified to yield the transmitted laser pulse 422, while the pump laser 418 provides the power (in the form of the energy deposited by the pump laser 418 into the optical amplifier 416). So, the optical amplifier 416 is fed by two inputs—the pump laser 418 (which deposits energy into the optical amplifier 416) and the seed laser 414 (which provides the signal that stimulates the energy in the optical amplifier 416 and induces pulse 422 to fire).

The optical amplifier 416 may take the form of a fiber amplifier, and the light source 402 may take the form of a fiber laser. The control circuitry 106 can maintain and update a laser energy model 408 that tracks the amount of energy in the light source 402 that is available for the laser pulses 422. The laser energy model 408 can model retention of energy in the light source 402 after laser pulse shots 422 and quantitatively predict the available energy amounts for laser pulse shots at specified times in the future based on a prior history of the laser pulse shots 422. For example, the laser energy model 408 can (1) model depletion of energy in the optical amplifier 416 in response to each laser pulse shot 422, (2) model retention of energy in the optical amplifier 416 after the laser pulse shots 422, and (3) model a buildup of energy in the optical amplifier 416 between laser pulse shots 416 to support these quantitative predictions of available energy in support of shot scheduling. Example embodiments for such laser energy modeling are described in U.S. Pat. No. 11,448,734, the entire disclosure of which is incorporated herein by reference. Based this laser energy modeling, the control circuitry 106 can schedule upcoming laser pulse shots 422 to ensure that there is sufficient energy for the shots 422 that will be used to illuminate the field of view 110.

The light source 402 fires laser pulses 422 in response to firing commands 420 received from the control circuitry 106. In an example where the light source 402 is a pulsed fiber laser source, the firing commands 420 can cause the seed laser 414 to induce pulse emissions by the fiber amplifier 416. In an example embodiment, the emitter 102 may employ non-steady state pulse transmissions, which means that there will be variable timing between the commands 420 to fire the light source 402. In this fashion, the laser pulses 422 transmitted by the emitter 102 will be spaced in time at irregular intervals. There may be periods of relatively high densities of laser pulses 422 and periods of relatively low densities of laser pulses 422. Examples of laser vendors that provide such variable charge time control include Luminbird and ITF.

In example embodiments, a fiber laser used as the light source 402 may exhibit laser wavelengths of 1.5 μm and available energies in a range of around hundreds of nano-Joules to around tens of micro-Joules, with timing controllable from hundreds of nanoseconds to tens of microseconds and with an average power range from around 25 milliwatts 0 to around 4 watts.

In an example embodiment, instead of firing higher-energy pulses, lower-energy pulses 422 can be fired in close proximity to each other by the emitter 102. Pixels in the focal plane array 318 can then integrate the signal over multiple shots 422. This enables operation by the system 100 with lower-energy pixels, which may reduce the cost and/or heat produced by the laser. For example, the pulses can be fired with 100× lower energy relative to conventional approaches in the art.

It should be understood that light sources other than fiber lasers can be used for the light source 402. For example, the light source 402 could be a VCSEL array that emits laser light. The VCSEL array can be combined with microlenses that direct the outgoing laser light in desired shapes/patterns.

The scanner 404 includes a mirror that is scannable to control where the emitter 102 is aimed. In the example embodiment of FIG. 4, the scanner 404 includes two mirrors—mirror 410 and mirror 412. Mirrors 410 and 412 can take the form of MEMS mirrors. However, it should be understood that a practitioner may choose to employ different types of scannable mirrors. Mirror 410 is positioned optically downstream from the light source 402 and optically upstream from mirror 412. In this fashion, a laser pulse 422 generated by the light source 402 will impact mirror 410, whereupon mirror 410 will reflect the pulse 422 onto mirror 412, whereupon mirror 412 will reflect the pulse 422 for transmission into the environment. It should be understood that the outgoing pulse 422 may pass through various transmission optics during its propagation from mirror 410 to mirror 412 and into the environment.

In the example of FIG. 4, mirror 410 can scan through a plurality of mirror scan angles to define where the emitter 102 is targeted along a first axis. This first axis can be an X-axis so that mirror 410 scans between azimuths (see azimuth direction 130 in FIG. 1). Mirror 412 can scan through a plurality of mirror scan angles to define where the emitter 102 is targeted along a second axis. The second axis can be orthogonal to the first axis, in which case the second axis can be a Y-axis so that mirror 412 scans between elevations (see elevation direction 132 in FIG. 1). The combination of mirror scan angles for mirror 410 and mirror 412 will define a particular {azimuth, elevation} coordinate to which the emitter 102 is targeted. These azimuth, elevation pairs can be characterized as {azimuth angles, elevation angles} and/or {rows, columns} that define coordinates in the field of view 110 which can be targeted with laser pulses 422 by the emitter 102.

A practitioner may choose to control the scanning of mirrors 410 and 412 using any of a number of scanning techniques.

In a particularly powerful embodiment, mirror 410 can be driven in a resonant mode according to a sinusoidal signal while mirror 412 is driven according to a step signal. In an example where mirror 410 scans through azimuth angles while mirror 412 scans through elevation angles, the step signal used to drive mirror 412 can vary as a function of the elevations for the coordinates in the field of view 110 to be targeted with laser pulses 422 by the emitter 102. Thus, in an example embodiment where the control circuitry 106 develops a shot list of ordered coordinates in the field of view 110 to be targeted with a sequence of laser pulse shots 422, this shot list can define the step signal used to drive the scanning of mirror 412 so that mirror 412 is driven in a point-to-point mode that varies as function of the elevations for the shots on the shot list.

In this fashion, mirror 410 can be operated as a fast-axis mirror while mirror 412 is operated as a slow-axis mirror. When operating in such a resonant mode, mirror 410 scans through scan angles in a sinusoidal pattern. In an example embodiment, mirror 410 can be scanned at a frequency in a range between around 100 Hz and around 20 kHz. In a preferred embodiment, mirror 410 can be scanned at a frequency in a range between around 10 kHz and around 15 kHz (e.g., around 12 kHz). As noted above, mirror 412 can be driven in a point-to-point mode according to a step signal that varies as a function of the coordinates to be targeted with laser pulses 422 by the emitter 102. Thus, if the emitter 102 is to fire a laser pulse 422 at a particular range point having an elevation of X, then the step signal can drive mirror 412 to scan to the elevation of X. When the emitter 102 is later to fire a laser pulse 422 at a particular range point having an elevation of Y, then the step signal can drive mirror 412 to scan to the elevation of Y. In this fashion, the scanner 404 can selectively target range points that are identified for targeting with laser pulses 422. It is expected that mirror 412 will scan to new elevations at a much slower rate than mirror 410 will scan to new azimuths. As such, mirror 410 may scan back and forth at a particular elevation (e.g., left-to-right, right-to-left, and so on) several times before mirror 412 scans to a new elevation. Thus, while the mirror 412 is targeting a particular elevation angle, the emitter 102 may fire a number of laser pulses 422 that target different azimuths at that elevation while mirror 410 is scanning through different azimuth angles. U.S. Pat. Nos. 10,078,133 and 10,642,029, the entire disclosures of which are incorporated herein by reference, describe examples of mirror scan control using techniques such as these (and others) which can be used in connection with the example embodiments described herein.

It should be understood that other scanning techniques can be used for mirrors 410 and 412. For example, mirror 410 can be driven to scan through its azimuth shot angles linearly with time (e.g., a triangle driving waveform).

Furthermore, it should be understood that mirrors 410 and 412 need not be MEMS mirrors. For example, mirrors 410 and 412 could be micro-actuated mirrors (e.g., mirrors that use electrodes on their backs and appropriate electrical signaling or use other mechanical actuation). Moreover, the mirrors 410 and 412 can be magnetically or electrostatically actuated. Further still, the emitter 102 need not employ multiple mirrors 410 and 412. For example, the emitter 102 can employ a single 2D mirror that can be steered to any positions along the azimuth-elevation axes; or the emitter 102 can employ a digital light processing (DLP) mirror to steer the light output 108.

It should also be understood that a practitioner may find it desirable in some use cases for mirror 410 to scan between elevations (e.g. scan in a resonant mode between elevations) while mirror 412 scans between azimuths (e.g., scan in a point-to-point mode between azimuths).

Control circuitry 106 includes logic that is arranged to coordinate the operation of light source 402 and scanner 404 so that laser pulses 422 are transmitted according to a desired shot pattern. In this regard, the control circuitry 306 coordinates the firing commands 420 provided to scanner 404 in combination with the mirror control signal(s) 430. In the example of FIG. 4, where the scanner 404 includes mirror 410 and mirror 412, the mirror control signal(s) 430 can include a first control signal that drives the scanning of mirror 410 and a second control signal that drives the scanning of mirror 412. Any of the mirror scan techniques discussed above can be used to control mirrors 410 and 412. For example, mirror 410 can be driven with a sinusoidal signal to scan mirror 410 in a resonant mode, and mirror 412 can be driven with a step signal that varies as a function of the coordinates in the field of view 110 to be targeted with laser pulses 422 to thereby scan mirror 412 in a point-to-point mode.

The control circuitry 106 can adaptively change the shot pattern for the emitter 404 based on defined criteria such as the identification of regions of interest within the field of view 110. For example, during the search mode as discussed above, the control circuitry 106 can define a shot pattern for the emitter 404 that exhibits a grid pattern of substantially uniformly spaced shots 422 of substantially equal shot energies. To accomplish this, the control circuitry 106 can define a shot list for this search mode shot pattern where there is a timing schedule for shot coordinates in the field of view 110 that are uniformly spaced in terms of azimuth and elevation angles. Firing commands 420 can then be issued by the control circuitry 106 when the mirrors 410 and 412 are in scan positions that target these shot coordinates from the shot list.

However, in other example embodiments the search mode shot pattern can exhibit a denser pattern of shots in fixed portions of the frame that are expected to contain the most distant (and therefore likely the dimmest) objects/targets (e.g., including a denser grid of shots 422 in the center of the frame if the center is expected to be the region where distant objects are most likely to be found (or where there is more of a desire to know about distant objects). Furthermore, in some embodiments, a practitioner may find it desirable for the shot energies to be reduced for portions of the field of view 110 deemed to be of less interest (e.g., firing lower energy shots toward the ground). Accordingly, it should be understood that practitioners can selectively choose the shot patterns and shot characteristics that are employed for the baseline search mode of operation by the camera system 100.

In response to the identification of a region of interest in the field of view 110, the control circuitry 106 can switch from the search mode to the targeted interrogation mode and target the identified region of interest with a denser shot pattern. To accomplish this, control circuitry 106 can update the shot list accordingly which in turn orchestrates the firing commands 420 and mirror control signals 430 to achieve the desired shot pattern for the targeted interrogation mode that exhibits an increase in the light energy that illuminates the identified region of interest.

A mirror motion model 458 maintained by the control circuitry 106 can predict the coordinates to which the mirrors 410 and 412 will be targeted at defined points in time. Moreover, as explained above, the laser energy model 408 can predict the amount of energy that is available for the shots 422 at defined points in time. Accordingly, control circuitry 106 can use the laser energy model 408 and mirror motion model 458 to schedule the shots 422 for transmission by the emitter 102 in accordance with the desired shot patterns for the search mode and targeted interrogation mode. The above-referenced and incorporated U.S. Pat. No. 11,448,734 provides additional details that describe how a laser energy model 408 and mirror motion model 458 can be used by control circuitry 106 to schedule a shot list of desired shots 422 and then execute the shot list to achieve a desired shot pattern.

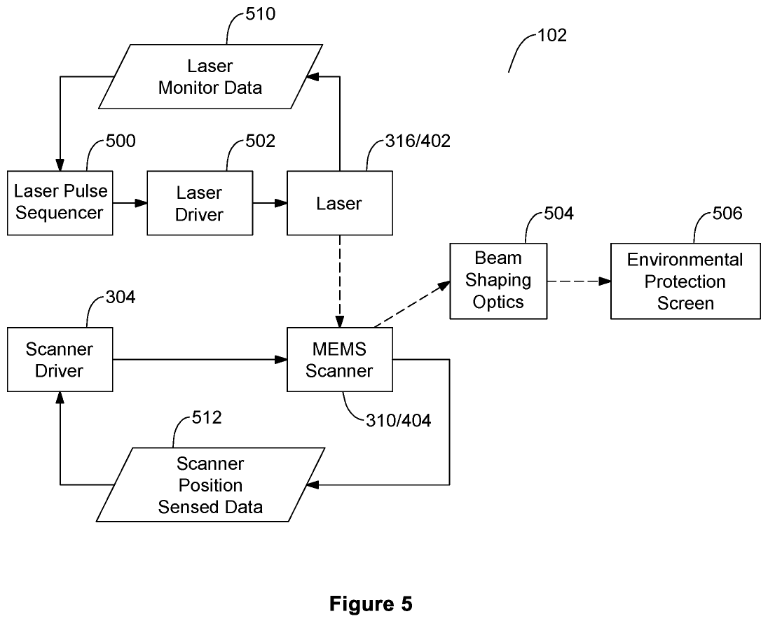

FIG. 5 shows an example system diagram for an example emitter 102. The laser pulse sequencer 500 sends timing, energy and pulse width instructions to the laser driver 502, which ensure that the laser 316/402 fires the pulses 422 as intended. A laser monitor 510, such as a photodiode, may measure the actual output of the laser 316/402, which may be different than the intended output due to temperature or other effects, and sends the monitor data back to the laser pulse sequencer 500 which may compensate for these effects. The laser pulse 422 impinges on the MEMS scanner 310/404 which steers the laser pulse 422 to the desired coordinates in the field of view 110.

The scanner driver 304 sends electrical instructions to the MEMS scanner 310/404 that operates to drive mirrors 410 and 412 in the appropriate scan pattern. A sensor on the MEMS scanner 310/404 may send electrical data regarding the physical position of the MEMS scanner 310/404 back to the scanner driver 304, so that the latter may compensate for temperature effects or other effects which may alter the position of the scanner from that baseline intended position (e.g., see the above-referenced and incorporated U.S. Pat. No. 10,078,133 which describes various feedback techniques that can be used to better control the accuracy of a scanner such as MEMS scanner 310/404).

Beam shaping optics 504 may be used to map the output of the MEMS scanner 310/404 to the desired field of illumination. For example, the MEMS scanner 310/404 may have a limited scan range, and the beam shaping optics 504 may extend this range. Alternately, the beam shaping optics 504 may increase or decrease the divergence angle of the light output 108. As an example, the beam shaping optics 504 may comprise a telescope lens which can stretch the beam in one or both axes and also extend or compress the field of illumination by the same amount. For example, a 30×30 field of illumination with a 0.1×0.1 degree beam divergence can be extended to a 60×30 scan with a 0.2×0.1 degree beam divergence.

The emitter 102 may also include an output aperture through which the laser pulses 422 are emitted into the field. This aperture may be covered by an environmental protection screen 506, which can take the form of an optically transparent or transmissive material that reduces the risk of internal components of the emitter 102 being contaminated with dirt, grime, debris, etc.

### Receiver 104:

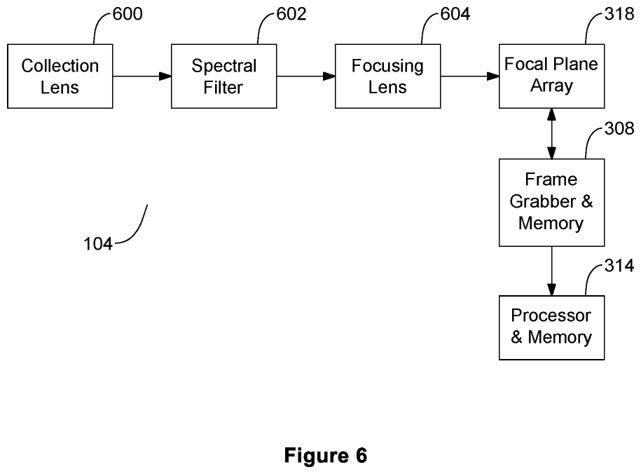

FIG. 6 shows an example architecture for receiver 104. The receiver 104 may include a collection lens 600, a spectral filter 602, a focusing lens 604, a photodetector array such as focal plane array 318 and a receiver board. Frame grabber 308 and associated memory can be deployed on the receiver board, as may be processor/memory 314. The receiver 104 may also include components such as thermal controls (active or passive coolers and/or heaters), a chassis, IO ports (wired or wireless), displays, and/or input devices (e.g., mouse, keyboard).

The collection lens 600 collects the incident light from the field of view 110, and collection lens 600 can be matched to the dimensions of the focal plane array 318. The spectral filter 602 transmits a sufficient portion of the incident light signal while reflecting a sufficient portion of background optical energy, such as light from the sun or other ambient optical sources. A practitioner can choose a spectral filter that reduces the effects of saturation and stray light/blooming when ambient light levels are high (e.g., when the sun is in the field of view). Unlike lidar, the spectral filter used for camera imaging can be less concerned with rejecting uncorrelated light (e.g., ambient light such as sunlight) that illuminates a target and reflects off it, which allows for the spectral filter 602 to exhibit a broader passband than would be used for lidar systems and translates into lower cost and smaller receive optics for the receiver 104. Focusing lens 604 focuses the light passed by the spectral filter 602 onto the focal plane array 318. The frame grabber 308 provides power, instructions and timing signals to the focal plane array 318 and connects it to the processor and memory 314 which processes and stores the image data 122 produced from the focal plane array 318.

In an example embodiment, the focal plane array 318 can be a sensor chip that comprises of an array of active-pixel sensors (APSs). Each APS can include a photodiode sensitive to the laser light used by emitter 102, e.g., InGaAs or Ge on Si sensitive to 1550 nm. With APSs, the charge accumulation can be achieved in-pixel (versus using a lot of real-estate), which enables the FPA circuitry to have a small number of amplifiers, e.g., 1, per array). However, it should be understood that other types of photodetectors could be used for the focal plane array 318 if desired by a practitioner, such as a photodetector array comprising p-i-n diodes, APD's, or photon-counting detectors, such as SPADs or SiPM.

In an example embodiment, the beam divergence (angular extent) of the laser pulses 422 may be larger than the field of view of a pixel within the focal plane array 318. However, it should be understood that this beam divergence could also be matched or smaller than the pixel field of view if desired by a practitioner.

Also, the receiver 104 can selectively read out signal from a subset of the pixels on the focal plane array 318 based on which pixels, over time, are expected to be imaging the zones that are illuminated by the laser pulses 422. The techniques that are described in U.S. Pat. No. 9,933,513 for reading out pixel subsets as a function of the targeting of laser pulses can be used in this regard. The entire disclosure of the '513 patent is incorporated herein by reference. For example, the control circuitry 106 can use a look-up table to determine which pixels or region of pixels on the focal plane array 318 will image the regions illuminated by the laser pulses 422 over time. Only those pixels which are expected to image the illuminated regions will be activated at a given time. This will reduce the dark noise integrated by each pixel. However, some practitioners may find it desirable to simply readout signal from all of the pixels of the focal plane array 318 at a given time.

In an example embodiment, the angular position of the target is attained by the pixel coordinates rather than by the emitter coordinate. In an example embodiment, when performing sensing for imaging, the pixels and associated signal processing circuitry do not need to process and digitize very fast signals (as compared to lidar systems). The focal plane array 318 and corresponding signal processing circuitry just need to collect photogenerated charge in each pixel over an integration time. Given that the SNR requirements for image sensing are much lower than for range measurements with a lidar system, as an example, the receiver 104 can record the light intensity across multiple smaller pixels and do a centroid analysis to find the precise position of an object. This can be instead of or in addition to the position information that can be obtained from the emitter 102.

Furthermore, with an example embodiment, the angular resolution of the system 100 is determined by the field of view for the focal plane array 318 divided by the number of pixels in each axis on the focal plane array 318, rather than by the emitter's beam divergence as it would be with lidar systems. With a lidar system, the angular resolution that can be achieved per shot is the beam divergence of the lidar system's emitter. For example, if the beam has a 1 degree divergence, we will not be able to know with better than one degree resolution where the object is. On the other hand, because the focal plane array 318 of the system 100 can measure the intensity at each pixel, and we can interpolate the precise position of an object at a resolution that is in fact better than the individual pixel's FOV (iFoV) (because we can use interpolation).

The field of view for the focal plane array 318 can be substantially the same as and overlapping with the field of illumination (FOI) for the emitter 102. For ease of reference, this shared FOI for the emitter 102 and field of view for the focal plane array 318 is referenced as the field of view 110. However, it should be understood that the FOI need not be the same as the field of view for the focal plane array 318, although it is desirable that they be substantially overlapping.

To sense and acquire the image data 122, the receiver 104 (via the focal plane array 318 and corresponding signal processing circuitry) can collect photo-generated charges at each pixel over an integration time. For example, photo-generated charges can be collected in a potential well in each pixel. At the end of the integration time, the quantity of collected charge is sensed via a shared bus (among a column of pixels) and digitized via an analog-to-digital converter (ADC).

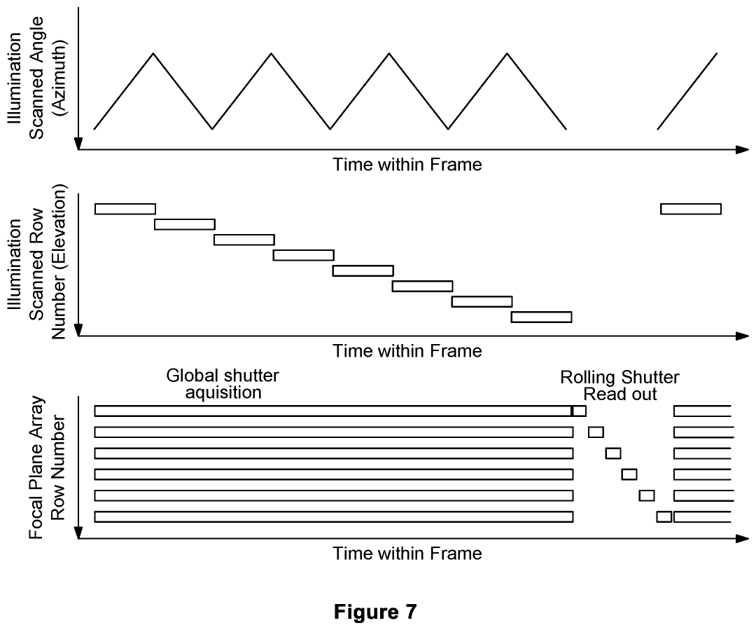

For example, the receiver 104 can employ global shutter acquisition to sense and acquire the image data 122. The readout of the acquired signals can then be performed using a rolling-shutter configuration. FIG. 7 shows an example system timing diagram for global shutter acquisition and rolling-shutter readout.

The top frame of FIG. 7 shows an example where the x-axis MEMS mirror 410 scans the light output 108 linearly with time (which can be sinusoidally or other waveforms). In the example of FIG. 7, the scanning is from one side to the other and then back for alternating row (next elevation). Thus, the y-MEMS mirror 412 steps between rows as shown by the middle frame of FIG. 7. The focal plane array 318 acquires signals for the duration of a complete scan of the field of view 110. All pixels on the focal plane array 318 can start and end the acquisition at the same time as indicated by the bottom frame of FIG. 7. The scan is halted at the end of a full scan while the collected electrical signals (e.g., voltages on in-pixel capacitors) are read-out row-by-row in a rolling-shutter configuration. The readout signals can then be digitized in column analog-to-digital converters (ADCs).

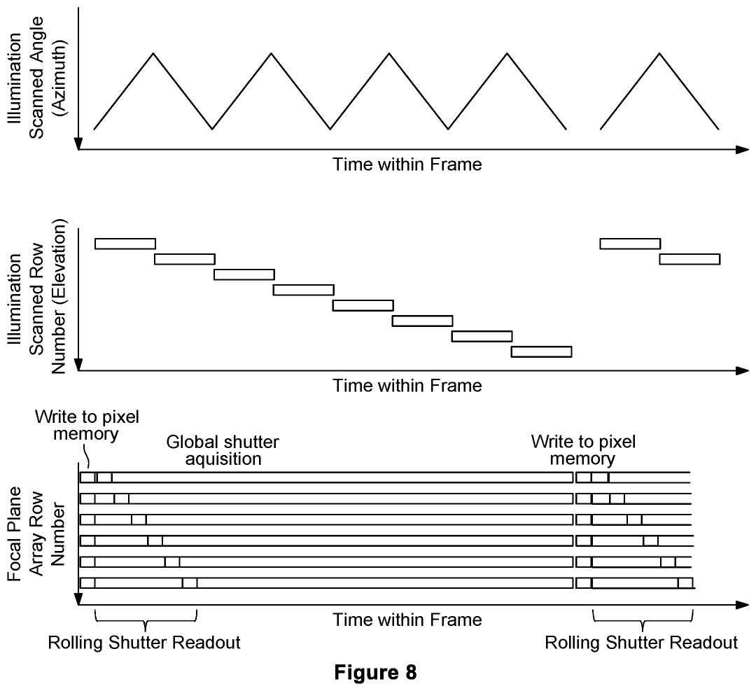

FIG. 8 shows an example timing diagram where global-shutter acquisition and rolling-shutter readout with in-pixel ping-pong logic is employed. The top frame and middle frame of FIG. 8 show how the azimuth and elevation scan angles for the emitter 102 will vary over time. In this example, each pixel of the focal plane array 318 comprises a first storage capacitor and a second storage capacitor. During global acquisition, charge is collected in the first storage capacitors of the pixels. At the end of an acquisition, the collected charge is transferred to the second storage capacitors, thus allowing a new acquisition to begin without having to wait for all rows to be read-out, as indicated by the bottom frame of FIG. 8 (where the boxes superimposed on each row of a given global acquisition shows readout for the previous global acquisition period). Thus, the acquisition off-time becomes significantly shorter with this arrangement as compared to the example of FIG. 7 because read-out can performed while the next frame is being acquired.

In another example embodiment, the receiver acquisition is rolling shutter and synchronized to the linear illumination of the emitter 102. For example, each row or group of rows of the photodetector pixels can integrate only when its viewed region is being illuminated (synchronization achieved by the system controller 302). This can be advantageous because the dark current of the photodetector pixel may create a dominant dark noise. Shortening the integration time by N will decrease the dark noise by square root of N.

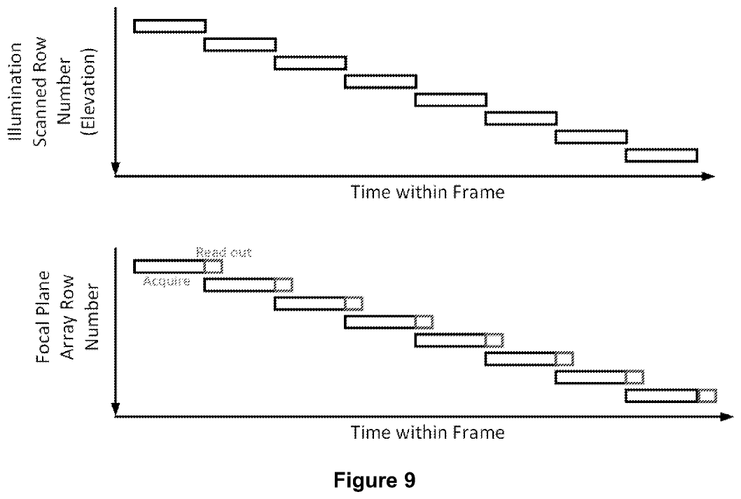

FIG. 9 shows an example timing diagram with rolling-shutter acquisition, synchronized to the vertical scanning of the emitter 102. In this example, the system is designed such that the number of rows scanned by the emitter 102 is identical to the number of rows in the focal plane array 318, and each row of the focal plane array 318 images a solid angle corresponding to the solid-angle illuminated by a single-row-scan of the emitter 102. Timing signals are provided by the system controller 302 to synchronize the integration time of each row of the focal plane array 318 with the scan time of the corresponding row of the emitter 102. Consequently integration time is reduced while the same signal is collected as in the scenarios above. This results in higher SNR because less background light and dark current is collected.

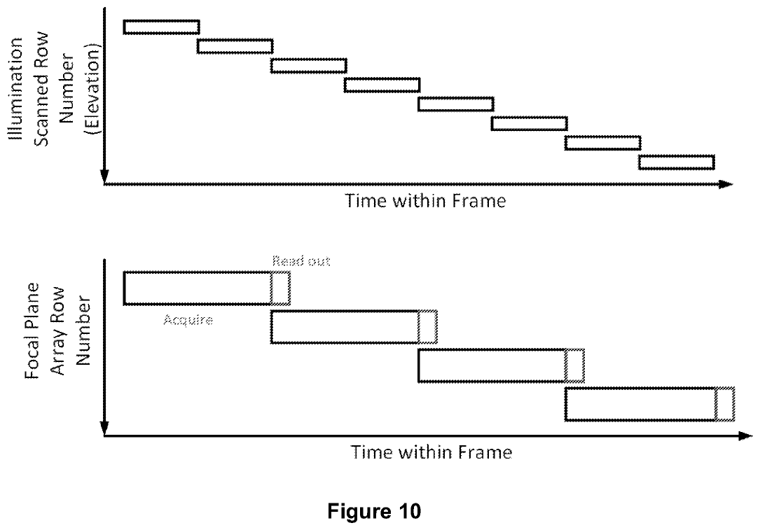

FIG. 10 shows an example where each illuminated row is imaged by more than one row in the focal plane array 318. However, it should be understood that the opposite scenario (where the focal plane array 318 images one row while the emitter 102 illuminates two or more rows) can also be employed if desired by a practitioner.

### Example Control Process for Example System Dataflow:

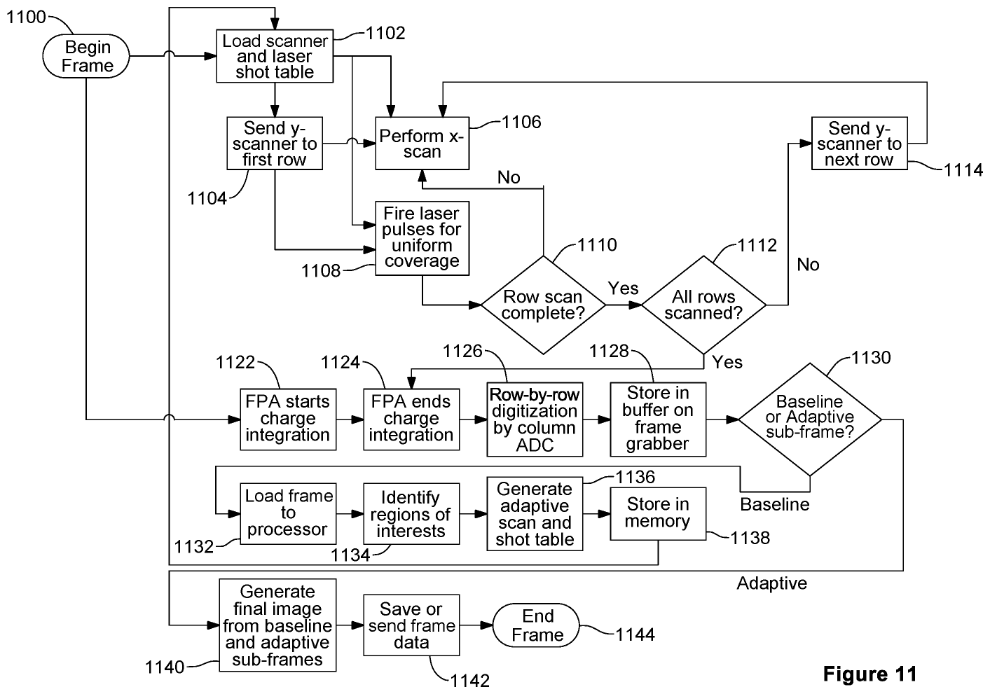

FIG. 11 shows an example process for the control circuitry 106 with respect to an example dataflow for the system 100.

At step 1100, the system begins a new frame. When beginning a new frame, the system can be operating in the search mode as discussed above. From step 1100, the system controls operations with respect to both the emitter 102 (see steps 1102 et seq.) and the receiver 104 (see steps 1122 et seq.) where the emitter 102 and receiver 104 are effectively operating in parallel with each other.

At step 1102, the emitter 102 loads a scanner table and laser shot table (e.g., the shot list) that defines the shot pattern for the emitter 102. At step 1104, the y-axis mirror 412 is driven to the first row (elevation angle) to be illuminated according to the shot list, and the x-axis mirror 410 performs its scan (step 1106), such as a resonant mode scan through azimuth angles. At step 1108, the emitter 102 fires laser pulses 422 in accordance with the shot list. As noted above, when operating in the search mode, the emitter 102 can fire laser pulse shots 422 in shot pattern that exhibits a uniform coverage of the field of view 110 where the shots 422 exhibit substantially uniform energy (step 1108). However, as noted above, different search mode shot patterns can be employed if desired by a practitioner.

Meanwhile, at step 1122, the focal plane array 318 and associated receiver electronics start charge integration. During imaging, at the beginning of the frame, the receiver's shutter (preferably electronic) opens at step 1122 for all pixels in the focal plane array 318.

In an example embodiment, during the search mode of operation, groups of pixels on the focal plane array 318 can be binned. This results in an increase of square-root of N (N binned pixels) at the expense of an N-times reduction in resolution. In an example embodiment, pulse energy for the shots 422 can be reduced by square-root of N during the search mode illumination via emitter 102 in order to maintain SNR. This low-energy illumination can be used to actively-image the whole field of view 110, resulting in a lower power consumption. Then, during subsequent operation in the targeted interrogation mode, higher-energy pulses 422 can selectively illuminate a much smaller solid angle (corresponding to the higher-information-content regions of the field of view 110 as identified as a result of step 1134 discussed below).

At step 1110, the control circuitry 106 determines whether a complete scan of the current row has occurred. If not, the process flow returns to step 1106 and continues to scan the x-axis mirror 410 while shots 422 are fired if dictated by the shot list (step 1108). If step 1110 results in a determination that the current row has been completely scanned, the process flow proceeds to step 1112.

At step 1112, the control circuitry 106 determines whether all rows of the frame have been scanned. If not, the process flow proceeds to step 1114 where the Y-axis mirror 412 is stepped to the next row (elevation angle) according to the shot list, and the x-axis mirror 410 continues to scan (step 1106) while shots 422 are fired if dictated by the shot list (step 1108). If step 1112 results in a determination that all of the rows has been scanned for the frame, the process flow proceeds to step 1124. At step 1124, the focal plane array 318 and associated receiver electronics end charge integration.

At step 1126, readout of the integrated charge collection from the focal plane array 318 occurs. This can be a rolling-shutter readout where a column ADC performs row-by-row digitization of the collected and integrated charge signals from the focal plane array 318. At step 1128, the digitized signal that represents the image data 122 is stored in a buffer on the frame grabber 308. This digitized signal serves as an image frame.

At step 1130, the control circuitry 1130 determines whether the system is operating in the search mode (baseline operations) or in the targeted interrogation mode (adaptive operations). If operating in the search mode, the process flow proceeds to step 1132. If operating in the targeted interrogation mode, the process flow proceeds to step 1140.

At step 1132, the processor 314 loads the image frame from the frame grabber 308. In this scenario, the loaded image frame serves as a search mode image frame (which can be characterized as a baseline sub-frame). The processor 314 then analyzes the loaded image frame to identify any regions of interest depicted therein (step 1134). As discussed above, any of a variety of image processing techniques can be used to identify these regions of interest, and the processor 314 may evaluate multiple image frames when performing these operations (e.g., comparing the current image frame with one or more previous image frames to detect areas of change). In a preferred embodiment, step 1134 is performed with a latency that is less than a frame time. To achieve low latency, compute resources that are capable of massive parallelization (such as FPGAs and ASICs) can be employed; and furthermore, efficient image processing algorithms can be employed such as edge detection, motion detection, and/or envelope detection.

At step 1136, the control circuitry generates an adaptive scan and shot table based on the identified region(s) of interest from step 1134. This adaptive scan and shot table will serve as a shot list to define a shot pattern for the targeted interrogation mode so that the system 100 will smartly and adaptively illuminate the identified region(s) of interest with additional light energy for further imaging. For example, the adaptive shot pattern can be defined by a shot list with a denser grid of shots within the region(s) of interest and/or higher shot energy for shots within the region(s) of interest.

At step 1138, this adaptive scan and shot table are loaded into memory, and the process flow returns to step 1102 to continue scanning by the emitter 102 in the targeted interrogation mode. The system can then (1) perform steps 1104, 1106, 1108, 1110, 1112, and 1114 so that the emitter 102 implements a dynamic adaptive scan and shot pattern for the targeted interrogation mode and (2) perform steps 1122, 1124, 1126, and 1128 when in the targeted interrogation mode (in which case the image frame produced by steps 1126 and 1128 would be a targeted interrogation mode image frame (which can be characterized as an adaptive sub-frame) that exhibits a higher resolution or SNR for the identified region(s) of interest. When the process flow returns to step 1130, this time the process flow will branch to step 1140 because the system is in the targeted interrogation mode.

At step 1140, the control circuitry 106 combines the search mode image frame (the baseline sub-frame) with the targeted interrogation mode image frame (the adaptive sub-frame) to generate the final image for the subject frame. As noted above, the control circuitry 106 can perform this combining operation by superimposing or replacing the region(s) of interest from the targeted interrogation mode image frame over the search mode image frame, by fusing the search mode image frame with the targeted interrogation mode image frame, or enhancing the search mode image frame with the targeted interrogation mode image frame. At step 1142, this final image frame is saved to memory or sent via system IO 312 to a desired destination, and the process flow for the subject frame ends (step 1144). This point, the process flow of FIG. 11 can begin anew at step 1100 for the next frame.

### Example Use Cases:

Example embodiments for the camera system 100 described can be deployed in any of a number of different use cases.

For example, the camera system 100 can be deployed as a low SNR trigger for a lidar system. The SNR threshold for imaging is typically significantly lower than it is for calculating range in a lidar system (e.g., an SNR of 2 vs 8). In an example embodiment of a camera trigger for a lidar system, the receiver 104 can use a current-mode pixel (e.g., p-i-n or APD). The search mode for the camera system 100 can produce a 2D image, e.g., by integrating the collected charge from each shot as collected by the predetermined pixels corresponding to the illuminated regions in the field of view 110. A processor can then analyze the 2D image(s) to identify the angles from which information-rich objects can be inferred to exist. Based on these identified angles, the control circuitry 106 can generate shot coordinates for the emitter 102 to sequence high-energy pulses 422 which can then be used for high-SNR acquisition for point cloud generation from which range information can be derived via the lidar system.

In an example embodiment of a camera trigger for the lidar system, two focal plane arrays can be used, each with its own collection lens-one focal plane array 318 for high-resolution 2D imaging (with a lens which can generate a small Point Spread Function on the imaging focal plane array 318) and one focal plane array for 3D point cloud generation (with a less-expensive lens which may generate a larger point spread function on the high-speed focal plane array), while concurrently being illuminated by the same emitter 102.

As another example, the camera system 100 can be deployed as a drone tracker. The emitter 102 can scan a large field of view 110 with low power density per solid angle. The receiver 104 and associated control circuitry 106 can then monitor for change (e.g., change in intensity between consecutive frames) and direct the emitter 102 to illuminate selected regions in the field of view 110 with more shots per solid angle (in the direction of the detected change), thus making it possible to image a drone that may be flying in the field of view 110 with higher SNR.

As another example, the camera system 100 can be deployed in a vehicle (e.g., a car, truck, etc.). As noted above, the camera system 100 may optionally be combined with a lidar system.

As yet another example, the camera system 100 can be deployed as a security camera. For example, the security camera can be used for applications such as border control. The security camera can scan a large field of view 110 at a low power density and image at low resolution when in the search mode. If motion is detected, the camera system 100 can switch to the targeted illumination mode and illuminate selected regions of interest in the field of view (e.g., where motion was detected) at a higher power density. To make such security monitoring more discreet, the light output 108 can exhibit wavelengths in a portion of the electromagnetic spectrum that is not visible to the human eye (e.g., infrared (IR) portions of the spectrum such as short wave infrared (SWIR)).

Accordingly, a number of example embodiments are described herein such as those listed below.

Embodiment A1. An active illumination camera system, the system comprising:
a light source that generates a light output for sequentially illuminating a scene to be imaged;
a scanner that scannably steers the light output to targeted regions in the scene;
a photodetector circuit comprising a photodetector array having a plurality of photodetector pixels that sense incident light from the scene, and wherein the photodetector circuit generates signals representative of the sensed incident light via integration of photo-generated charge for the pixels over time;
a circuit that (1) generates image frames of the scene based on the generated signals, (2) identifies regions of interest in the scene, and (3) dynamically controls the light source and the scanner so that the steered light output exhibits a pattern that targets the identified regions with an increase in light energy.

Embodiment A2. The system of Embodiment A1 wherein the circuit controls the scanner to switch between a search mode and a targeted interrogation mode based on defined criteria;
wherein the scanner, during the targeted interrogation mode, is controlled to increase a density of the light output to an identified region of interest per image frame relative to the search mode.

Embodiment A3. The system of Embodiment A2 wherein the defined criteria comprises an identification of a region of interest within the scene.

Embodiment A4. The system of any of Embodiments A2-A3 wherein the circuit controls the scanner and the light source during the search mode to steer the light output in a uniform scan pattern through the scene.

Embodiment A5. The system of any of Embodiments A2-A4 wherein the circuit (1) generates a first image frame in response to operation in the search mode during a first time period and (2) generates a second image frame in response to operation in the targeted interrogation mode during a second time period.

Embodiment A6. The system of Embodiment A5 wherein the circuit combines the first and second image frames.

Embodiment A7. The system of any of Embodiments A1-A6 wherein the scanner comprises:
a first mirror that is scannable with respect to a first axis;
a second mirror that is scannable with respect to a second axis; and
a scanner drive circuit that (1) drives the first mirror to scan along the first axis in a resonant mode and (2) drives the second mirror to scan along the second axis in a step mode that varies as a function of a shot list defined by the circuit; and
wherein the circuit dynamically controls the light source and the scanner so that the steered light output exhibits a shot pattern in accordance with the shot list.

Embodiment A8. The system of Embodiment A7 wherein the circuit generates the shot list, wherein the shot list comprises a plurality of shot coordinates in the scene for the region of interest to target with the steered light output, each shot coordinate comprising a coordinate along the first axis and a coordinate along the second axis.

Embodiment A9. The system of any of Embodiments A7-A8 wherein the first and second mirrors comprise MEMS mirrors.

Embodiment A10. The system of any of Embodiments A1-A9 wherein the circuit processes one or more previous image frames to identify one or more of the regions of interest.

Embodiment A11. The system of Embodiment A10 wherein the circuit monitors the one or more previous image frames to detect motion of an object depicted in the image frames, wherein the identified regions of interest include a region corresponding to the detected motion.

Embodiment A12. The system of any of Embodiments A10-A11 wherein the circuit processes one or more of the previous image frames to detect a shape of interest, wherein the identified regions of interest include a region corresponding to the detected shape of interest.

Embodiment A13. The system of any of Embodiments A1-A12 wherein the photodetector array comprises an array of active-pixel sensors.

Embodiment A14. The system of Embodiment A13 wherein the active-pixel sensors comprise CMOS sensors.

Embodiment A15. The system of any of Embodiments A1-A14 further comprising: receive optics that collect incident light from the scene and focuses the collected incident light on the photodetector array.

Embodiment A16. The system of Embodiment A15 wherein the receive optics comprise:
a collection lens that collects the incident light from the scene;
a spectral filter that filters the collected incident light to reduce noise; and
a focusing lens that focuses the filtered collected incident light onto the photodetector array.

Embodiment A17. The system of any of Embodiments A1-A16 wherein the integration time corresponds to a full scan of the scene.

Embodiment A18. The system of any of Embodiments A1-A16 wherein the integration time corresponds to a scan of a row of the scene.

Embodiment A19. The system of any of Embodiments A1-A18 wherein the circuit generates the image frames based on a global shutter acquisition.

Embodiment A20. The system of Embodiment A19 wherein the circuit uses a rolling shutter readout to read the generated signals from the photodetector pixels.

Embodiment A21. The system of Embodiment A20 wherein the circuit synchronizes the rolling shutter readout to a pattern based on changes in the scan pattern in terms of elevation or azimuth.

Embodiment A22. The system of Embodiment A21 wherein the scan pattern exhibits a number of rows that is the same as a number of rows of the photodetector pixels in the photodetector array.

Embodiment A23. The system of any of Embodiments A20-A22 wherein the rolling shutter readout comprises a row-by-row read of the photodetector pixels in the photodetector array.

Embodiment A24. The system of any of Embodiments A1-A23 wherein each of a plurality of the photodetector pixels comprises a first storage capacitor and a second storage capacitor, wherein the sensed incident light produces collected charge in the first storage capacitor during a first acquisition period for the photodetector array, wherein the collected charge from the first acquisition period is transferred to the second storage capacitor at the end of the first acquisition period to free the first storage capacitor for collecting charge during a second acquisition period; and
wherein the circuit reads out the collected charge from the first acquisition period from the second storage capacitors during the second acquisition period, wherein read out collected charge from the first acquisition is used to generate an image frame corresponding to the first acquisition period.

Embodiment A25. The system of any of Embodiments A1-A24 wherein the circuit comprises a frame grabber circuit that generates the image frames based on the generated signals.

Embodiment A26. The system of any of Embodiments A1-A25 wherein the circuit comprises a processor that processes the image frames to dynamically control the scanner.

Embodiment A27. The system of any of Embodiments A1-A26 wherein the circuit comprises a system controller that provides commands and timing signals the scanner and light source.

Embodiment A28. The system of any of Embodiments A1-A27 wherein the light source comprises a laser emitter.

Embodiment A29. The system of Embodiment A28 wherein the laser emitter comprises a fiber laser.

Embodiment A30. The system of any of Embodiments A1-A29 comprising:
a first aperture through which the steered light output is transmitted into the scene; and
a second aperture through which the photodetector array receives incident light from the scene;
wherein the first and second apertures are in a bistatic relationship with each other.

Embodiment A31. The system of any of Embodiments A1-A30 wherein the light output comprises a plurality of laser pulse shots, wherein the circuit dynamically controls (1) an amount of optical energy emitted per solid angle in the field of view by determining (i) energy amounts for the laser pulse shots and (ii) timing for the laser pulse shots and (2) the scanner so that the laser pulse shots are deposited in the field of view based on predefined heuristics.

Embodiment A32. The system of any of Embodiments A1-A31 wherein the image frames are 2D images.

Embodiment A33. The system of any of Embodiments A1-A32 wherein the camera system is arranged as a security camera.

Embodiment A34. The system of any of Embodiments A1-A33 wherein the steered light output exhibits a wavelength in a portion of the electromagnetic spectrum that is not visible to a human eye.

Embodiment A35. The system of Embodiment A34 wherein the steered light output comprises infrared light.

Embodiment A36. The system of any of Embodiments A1-A32 wherein the camera system is arranged as a drone tracker.

Embodiment A37. The system of any of Embodiments A1-A32 wherein the camera system is arranged for mounting and/or integration with a vehicle.

Embodiment A38. The system of any of Embodiments A1-A32 wherein the camera system is arranged as a trigger for a lidar system, the lidar system comprising a second photodetector array from which a three-dimensional point cloud of the scene is generated.

Embodiment B1. A method for imaging a scene using active illumination, the method comprising:
generating a light output for sequentially illuminating the scene to be imaged;
scanning the light output to targeted regions in the scene;
sensing incident light from the scene via a plurality of photodetector pixels of a photodetector array;
generating signals representative of the sensed incident light via integration of photo-generated charge for the pixels over time;
generating image frames of the scene based on the generated signals;
identifying regions of interest in the scene; and
dynamically controlling the scanning step and the light output generating step so that the scanned light output exhibits a pattern that targets the identified regions with an increase in light energy.

Embodiment B2. The method of Embodiment B1 wherein the dynamically controlling step comprises:
switching between a search mode and a targeted interrogation mode based on defined criteria; and
during the targeted interrogation mode, increasing a density of the light output to an identified region of interest per image frame relative to the search mode.

Embodiment B3. The method of Embodiment B2 wherein the defined criteria comprises an identification of a region of interest within the scene.

Embodiment B4. The method of any of Embodiments B2-B3 wherein the dynamically controlling step comprises, during the search mode, steering the light output in a uniform scan pattern through the scene.

Embodiment B5. The method of any of Embodiments B2-B4 wherein the step of generating image frames comprises (1) generating a first image frame in response to operation in the search mode during a first time period and (2) generating a second image frame in response to operation in the targeted interrogation mode during a second time period.

Embodiment B6. The method of Embodiment B5 wherein the step of generating image frames further comprises combining the first and second image frames.

Embodiment B7. The method of any of Embodiments B1-B6 wherein the scanning step comprises:
scanning a first mirror with respect to a first axis in a resonant mode; and
scanning a second mirror with respect to a second axis in a step mode that varies as a function of a shot list; and
wherein the dynamically controlling step comprises dynamically controlling the second mirror scanning step and the light output generating step so that the steered light output exhibits a shot pattern in accordance with the shot list.

Embodiment B8. The method of Embodiment B7 further comprising:
generating the shot list, wherein the shot list comprises a plurality of shot coordinates in the scene for the region of interest to target with the steered light output, each shot coordinate comprising a coordinate along the first axis and a coordinate along the second axis.

Embodiment B9. The method of any of Embodiments B7-B8 wherein the first and second mirrors comprise MEMS mirrors.

Embodiment B10. The method of any of Embodiments B1-B9 wherein the identifying step comprises processing one or more previous image frames to identify one or more of the regions of interest.

Embodiment B11. The method of Embodiment B10 wherein the processing step comprises monitoring the one or more previous image frames to detect motion of an object depicted in the image frames, wherein the identified regions of interest include a region corresponding to the detected motion.

Embodiment B12. The method of any of Embodiments B10-B11 wherein the identifying step comprises detecting a shape of interest based on the processed one or more previous image frames, wherein the identified regions of interest include a region corresponding to the detected shape of interest.

Embodiment B13. The method of any of Embodiments B1-B12 wherein the photodetector array comprises an array of active-pixel sensors.

Embodiment B14. The method of Embodiment B13 wherein the active-pixel sensors comprise CMOS sensors.

Embodiment B15. The method of any of Embodiments B1-B14 further comprising:
collecting incident light from the scene and focusing the collected incident light on the photodetector array.

Embodiment B16. The method of Embodiment B15 wherein the collecting step comprises collecting the incident light from the scene via a collection lens that collects the incident light from the scene;
the method further comprising filtering the collected incident light via a spectral filter to reduce noise; and
wherein the focusing step comprises focusing the filtered collected incident light onto the photodetector array via a focusing lens.

Embodiment B17. The method of any of Embodiments B1-B16 wherein the integration time corresponds to a full scan of the scene.

Embodiment B18. The method of any of Embodiments B1-B16 wherein the integration time corresponds to a scan of a row of the scene.

Embodiment B19. The method of any of Embodiments B1-B18 wherein the step of generating signals comprises generating the signals based on a global shutter acquisition.

Embodiment B20. The method of Embodiment B19 further comprising:
using a rolling shutter readout to read the generated signals from the photodetector pixels.

Embodiment B21. The method of Embodiment B20 wherein the using step comprises synchronizing the rolling shutter readout to a pattern based on changes in the scan pattern in terms of elevation or azimuth.

Embodiment B22. The method of Embodiment B21 wherein the scan pattern exhibits a number of rows that is the same as a number of rows of the photodetector pixels in the photodetector array.

Embodiment B23. The method of any of Embodiments B20-B22 wherein the rolling shutter readout comprises a row-by-row read of the photodetector pixels in the photodetector array.

Embodiment B24. The method of any of Embodiments B1-B23 wherein each of a plurality of the photodetector pixels comprises a first storage capacitor and a second storage capacitor;
wherein the sensing step comprises collecting charge in the first storage capacitor during a first acquisition period for the photodetector array;
wherein the step of generating signals comprises (1) transferring the collected charge from the first acquisition period to the second storage capacitor at the end of the first acquisition period to free the first storage capacitor for collecting charge during a second acquisition period and (2) reading out the collected charge from the first acquisition period from the second storage capacitors during the second acquisition period, wherein read out collected charge from the first acquisition is used to generate an image frame corresponding to the first acquisition period.

Embodiment B25. The method of any of Embodiments B1-B24 wherein a frame grabber circuit performs the step of generating image frames.

Embodiment B26. The method of any of Embodiments B1-B25 wherein the dynamically controlling step includes processing the generated image frames using a processor.

Embodiment B27. The method of any of Embodiments B1-B26 further comprising providing commands and timing signals for the light output generating and scanning steps.

Embodiment B28. The method of any of Embodiments B1-B27 wherein the light output comprises laser light.

Embodiment B29. The method of Embodiment B28 wherein the light output generating step comprises emitting laser light using a fiber laser.

Embodiment B30. The method of any of Embodiments B1-B29 further comprising:
transmitting the steered light output into the scene through a first aperture; and
receiving incident light from the scene through a second aperture for passage to the photodetector array;
wherein the first and second apertures are in a bistatic relationship with each other.

Embodiment B31. The method of any of Embodiments B1-B30 wherein the light output comprises a plurality of laser pulse shots, wherein the dynamically controlling step comprises (1) controlling an amount of optical energy emitted per solid angle in the field of view by determining (i) energy amounts for the laser pulse shots and (ii) timing for the laser pulse shots and (2) controlling the scanning step so that the laser pulse shots are deposited in the field of view based on predefined heuristics.

Embodiment B32. The method of any of Embodiments B1-B31 wherein the image frames are 2D images.

Embodiment B33. The method of any of Embodiments B1-B32 wherein the method steps are performed as part of security camera operations.

Embodiment B34. The method of any of Embodiments B1-B33 wherein the steered light output exhibits a wavelength in a portion of the electromagnetic spectrum that is not visible to a human eye.

Embodiment B35. The method of Embodiment B34 wherein the steered light output comprises infrared light.

Embodiment B36. The method of any of Embodiments B1-B32 wherein the method steps are performed as part of drone tracker operations.

Embodiment B37. The method of any of Embodiments B1-B32 wherein the method steps are performed by a camera system that is mounted and/or integrated with a vehicle.

Embodiment B38. The method of any of Embodiments B1-B32 wherein the method steps are performed by a camera system that is arranged as a trigger for a lidar system, the lidar system comprising a second photodetector array from which a three-dimensional point cloud of the scene is generated.

Embodiment C1. An article of manufacture for control of an active illumination camera system, the camera system comprising a light source, a scanner, a photodetector array comprising a plurality of photodetector pixels, and a processor, the article comprising:
machine-readable code that is resident on a non-transitory machine-readable storage medium, wherein the code defines processing operations to be performed by the processor to cause the processor to:
   generate first control signals for commanding the light source to generate a light output for sequentially illuminating a scene to be imaged;
   generate second control signals for commanding the scanner to scan the light output to targeted regions in the scene;
   integrate photo-generated charge for the pixels over time to generate signals representative of incident light sensed by the photodetector array;
   process image frames of the scene that are derived from the generated signals representative of the sensed incident light;
   identify regions of interest in the scene; and
   dynamically control the first and second control signals so that the scanned light output exhibits a pattern that targets the identified regions with an increase in light energy.

Embodiment C2. The article of manufacture of Embodiment C1 further comprising any feature or combination of features set forth by any of Embodiments A1-B38.

While the invention has been described above in relation to its example embodiments, various modifications may be made thereto that still fall within the invention's scope. These and other modifications to the invention will be recognizable upon review of the teachings herein.

1. An active illumination camera system, the system comprising:
a light source that generates a light output for sequentially illuminating a scene to be imaged;
a scanner that scannably steers the light output to targeted regions in the scene;
a photodetector circuit comprising a photodetector array having a plurality of photodetector pixels that sense incident light from the scene, wherein the photodetector circuit generates signals representative of the sensed incident light via integration of photo-generated charge for the photodetector pixels over time;
a circuit that generates image frames of the scene based on the generated signals, identifies regions of interest in the scene, and dynamically controls the light source and the scanner so that the steered light output exhibits a pattern that targets the identified regions with an increase in light energy.

2. The system of claim 1 wherein the circuit controls the scanner to switch between a search mode and a targeted interrogation mode based on defined criteria;
wherein the scanner, during the targeted interrogation mode, is controlled to increase a density of the light output to an identified region of interest per image frame relative to the search mode.

3. The system of claim 2 wherein the defined criteria comprise an identification of a region of interest within the scene.

4. The system of claim 2 wherein the circuit controls the scanner and the light source during the search mode to steer the light output in a uniform scan pattern through the scene.

5. The system of claim 2 wherein the circuit generates a first image frame in response to operation in the search mode during a first time period and generates a second image frame in response to operation in the targeted interrogation mode during a second time period.

6. The system of claim 5 wherein the circuit combines the first and second image frames.

7. The system of claim 1 wherein the scanner comprises:
a first mirror that is scannable with respect to a first axis;
a second mirror that is scannable with respect to a second axis; and
a scanner drive circuit that drives the first mirror to scan along the first axis in a resonant mode and drives the second mirror to scan along the second axis in a step mode that varies as a function of a shot list defined by the circuit;
wherein the circuit dynamically controls the light source and the scanner so that the steered light output exhibits a shot pattern in accordance with the shot list.

8. The system of claim 7 wherein the circuit generates the shot list, wherein the shot list comprises a plurality of shot coordinates in the scene for the region of interest to target with the steered light output, each shot coordinate comprising a coordinate along the first axis and a coordinate along the second axis.

9. The system of claim 7 wherein the first and second mirrors comprise MEMS mirrors.

10. The system of claim 1 wherein the circuit processes one or more previous image frames to identify one or more of the regions of interest.

11. The system of claim 10 wherein the circuit monitors the one or more previous image frames to detect motion of an object depicted in the image frames, wherein the identified one or more regions of interest include a region corresponding to the detected motion.

12. The system of claim 10 wherein the circuit processes one or more of the previous image frames to detect a shape of interest, wherein the one or more identified regions of interest include a region corresponding to the detected shape of interest.

13. The system of claim 1 wherein the photodetector array comprises an array of active-pixel sensors.

14. The system of claim 13 wherein the active-pixel sensors comprise CMOS sensors.

15. The system of claim 1 further comprising:
receive optics that collect the incident light from the scene and focus the collected incident light on the photodetector array.

16. The system of claim 15 wherein the receive optics comprise:
a collection lens that collects the incident light from the scene;
a spectral filter that filters the collected incident light to reduce noise; and
a focusing lens that focuses the filtered collected incident light on the photodetector array.

17. The system of claim 1 wherein a time of the integration corresponds to a full scan of the scene.

18. The system of claim 1 wherein a time of the integration corresponds to a scan of a row of the scene.

19. The system of claim 1 wherein the circuit generates the image frames based on a global shutter acquisition.

20. The system of claim 19 wherein the circuit uses a rolling shutter readout to read the generated signals from the photodetector pixels.

21. The system of claim 20 wherein the circuit synchronizes the rolling shutter readout to a pattern based on changes in the scan pattern in terms of elevation or azimuth.

22. The system of claim 21 wherein the scan pattern exhibits a number of rows that is the same as a number of rows of the photodetector pixels in the photodetector array.

23. The system of claim 20 wherein the rolling shutter readout comprises a row-by-row read of the photodetector pixels in the photodetector array.

24. The system of claim 1 wherein each of a plurality of the photodetector pixels comprises a first storage capacitor and a second storage capacitor, wherein the sensed incident light produces collected charge in the first storage capacitor during a first acquisition period for the photodetector array, wherein the collected charge from the first acquisition period is transferred to the second storage capacitor at the end of the first acquisition period to free the first storage capacitor for collecting charge during a second acquisition period; and wherein the circuit reads out the collected charge from the first acquisition period from the second storage capacitors during the second acquisition period, wherein read out collected charge from the first acquisition is used to generate an image frame corresponding to the first acquisition period.

25. The system of claim 1 wherein the circuit comprises a frame grabber circuit that generates the image frames based on the generated signals.

26. The system of claim 1 wherein the circuit comprises a processor that processes the image frames to dynamically control the scanner.

27. The system of claim 1 wherein the circuit comprises a system controller that provides commands and timing signals to the scanner and the light source.

28. The system of claim 1 wherein the light source comprises a laser emitter.

29. The system of claim 28 wherein the laser emitter comprises a fiber laser.

30. The system of claim 1 comprising:
a first aperture through which the steered light output is transmitted into the scene; and
a second aperture through which the photodetector array receives the incident light from the scene;
wherein the first and second apertures are in a bistatic relationship with each other.

31. The system of claim 1 wherein the light output comprises a plurality of laser pulse shots, wherein the circuit dynamically controls (1) an amount of optical energy emitted per solid angle in a field of view by determining (i) energy amounts for the laser pulse shots and (ii) timing for the laser pulse shots and (2) the scanner so that the laser pulse shots are deposited in the field of view based on predefined heuristics.

32. The system of claim 1 wherein the image frames are 2D images.

33. The system of claim 1 wherein the camera system is arranged as a security camera.

34. The system of claim 1 wherein the steered light output exhibits a wavelength in a portion of the electromagnetic spectrum that is not visible to a human eye.

35. The system of claim 34 wherein the steered light output comprises infrared light.

36. The system of claim 1 wherein the camera system is arranged as a drone tracker.

37. The system of claim 1 wherein the camera system is arranged for mounting and/or integration with a vehicle.

38. The system of claim 1 wherein the camera system is arranged as a trigger for a lidar system, the lidar system comprising a second photodetector array from which a three-dimensional point cloud of the scene is generated.

39. A method for imaging a scene using active illumination, the method comprising:
generating a light output for sequentially illuminating the scene to be imaged;
scanning the light output to targeted regions in the scene;
sensing incident light from the scene via a plurality of photodetector pixels of a photodetector array;
generating signals representative of the sensed incident light via integration of photo-generated charge for the photodetector pixels over time;
generating image frames of the scene based on the generated signals;
identifying regions of interest in the scene; and
dynamically controlling the scanning step and the light output generating step so that the scanned light output exhibits a pattern that targets the identified regions with an increase in light energy.

40. An article of manufacture for control of an active illumination camera system, the camera system comprising a light source, a scanner, a photodetector array comprising a plurality of photodetector pixels, and a processor, the article comprising:
machine-readable code that is resident on a non-transitory machine-readable storage medium, wherein the code defines processing operations to be performed by the processor to cause the processor to:
generate first control signals for commanding the light source to generate a light output for sequentially illuminating a scene to be imaged;
generate second control signals for commanding the scanner to scan the light output to targeted regions in the scene;
integrate photo-generated charge for the photodetector pixels over time to generate signals representative of incident light sensed by the photodetector array;
process image frames of the scene that are derived from the generated signals representative of the sensed incident light;
identify regions of interest in the scene; and
dynamically control the first and second control signals so that the scanned light output exhibits a pattern that targets the identified regions with an increase in light energy.

41. (canceled)
